(19) United States
(12) Patent Application Publication
(10) Pub. No.: US 2025/0099937 A1
(43) Pub. Date: Mar. 27, 2025

(54) METHOD FOR MONITORING AND/OR CONTROLLING A CHEMICAL PLANT USING HYBRID MODELS

(71) Applicant: BASF SE, Ludwigshafen am Rhein (DE)

(72) Inventors: Satya Swarup SAMAL, Ludwigshafen am Rhein (DE); Olga WALZ, Ludwigshafen (DE); Hayder SCHNEIDER, Ludwigshafen am Rhein (DE)

(21) Appl. No.: 18/294,753

(22) PCT Filed: Jul. 27, 2022
(86) PCT No.: PCT/EP2022/071062

§ 371 Date: Feb. 2, 2024

(30) Foreign Application Priority Data
Aug. 6, 2021 (EP) 21190103.8

(51) Int. Cl. B01J 19/00; G05B 13/02

(52) U.S. Cl. CPC B01J 19/0033; G05B 13/027; B01J 2219/00193; B01J 2219/00211; B01J 2219/00227

(57) ABSTRACT

The present invention relates to a computer-implemented method for monitoring and/or controlling a chemical plant. Specifically, the present invention relates to a computer-implemented method for monitoring and/or controlling a physical-chemical process in a chemical plant comprising:
(a) receiving sensor data related to the physical-chemical process,
(b) determining at least one physical-chemical parameter by providing the sensor data to a plant model, wherein the plant model comprises
   a mechanistic model containing at least two equations each representing a part of the physical-chemical process and
   a data-driven model associated to the mechanistic model, wherein the total number of scalars as output parameters from the data-driven model is lower than the number of equations of the mechanistic model, and
(c) outputting the at least one physical-chemical parameter determined by the plant model.

The present invention relates to a computer-implemented method for monitoring and/or controlling a chemical plant.

Modern chemical plants are highly optimized to obtain the maximum output and the minimum side products. This enables offering chemical products at reasonably low price and generating a minimum of side products which may impact the environment. Various physical-chemical processes take place in a chemical plant. For example, a particularly effective method used in chemical plants is continuous reactor for a chemical reaction: The reagents are continuously fed into a reactor while the product is continuously output from the reactor. While some physical-chemical values like temperature and pressure as well as the quality of the product can be relatively easily determined, for example with sensors, many other important physical-chemical values like catalyst degradation cannot be directly measured. In order to maximize the efficiency of a chemical plant it is, however, important to have as detailed information about all physical-chemical values in a chemical plant as possible. Ideally, such information can be obtained in real-time.

A very useful way of obtaining such “hidden” physical-chemical value from a chemical plant is using the accessible sensor data and subject them to a physical model, which can calculate physical-chemical values not readily measurable by applying laws of physics or physical chemistry. A lot of such models have been developed. Nevertheless, not all details in a chemical plant are well understood, so the models are limited. To improve these models it has been suggested to add data-driven models. These are also called black-box models because they do not readily reveal how they arrive at their output from their input in contrast to the physical models.

G. D. Bellos et al. disclose in Chemical Engineering and Processing, volume 44 (2005), pages 505-515 the modelling of the performance of industrial hydro-desulphuration reactors using a hybrid neural network approach. A neural network is applied for the determination of kinetic parameters of the reaction as well as the reaction enthalpy and a hydrogen consumption constant. Hence, the neural network outputs four parameters for one single reaction. This approach works well if sufficient historic data is available to train the neural network. The authors had data of three different plants operating the same way. However, in most cases there is not a lot of historic data available. This is in particular true for new plants or those making specialty products.

Even worse, in these cases, there are often not even well-fitting physical models available, so a data-driven model needs to compensate even more than for well-known processes.

It was therefore an object of the present invention to provide a method to monitor and/or control a chemical plant which allows accurate determination of physical-chemical values with a minimum of historic data. It was aimed to provide a method which can easily be applied to different chemical plants, even if their production processes are mechanistically not very well understood. The method should be easy to implement and use a minimum of resources while producing results of high accuracy. The results of the method should be available in a short period of time to allow quick adjustments of the plant if its operation starts to deviate from its optimum to allow high product yield and a minimum of undesired side products and greenhouse gas emission.

The above-mentioned objects were achieved by a computer-implemented method for monitoring and/or controlling a physical-chemical process in a chemical plant comprising:
(a) receiving sensor data related to the physical-chemical process,
(b) determining at least one physical-chemical parameter by providing the sensor data to a plant model, wherein the plant model comprises:
   a mechanistic model containing at least two equations each representing a part of the physical-chemical process, and
   a data-driven model associated to the mechanistic model, wherein the data-driven model has been trained with a training dataset based on sets of historical data comprising sensor data and physical-chemical parameters related to the chemical reaction and wherein the total number of scalars as output parameters from the data-driven model is lower than the number of equations of the mechanistic model, and
(c) outputting the at least one physical-chemical parameter determined by the plant model.

The present invention further relates to a non-transitory computer-readable data medium storing a computer program including instructions for executing steps of the method according to the present invention.

The present invention further relates to the use of the physical-chemical parameter obtained by the method according to present invention for monitoring and/or controlling a chemical plant.

The present invention further relates to a production monitoring and/or control system for monitoring and/or controlling a physical-chemical process in a chemical plant comprising:
(a) an input configured to receive sensor data related to the physical-chemical process,
(b) a processor configured to determine at least one physical-chemical parameter by providing the sensor data to a plant model, wherein the plant model comprises:
   a mechanistic model containing at least two equations each representing a part of the physical-chemical process, and
   at least one data-driven model associated to the mechanistic model, wherein the data-driven model has been trained with a training dataset based on sets of historical data comprising sensor data and physical-chemical parameters related to the chemical reaction and wherein the total number of scalars as output parameters from the at least one data-driven model is lower than the number of equations of the mechanistic models, and
(c) an output configured to output the at least one physical-chemical parameter determined by the plant model.

The present invention further relates to a method for training a plant model suitable for determining at least one physical-chemical parameter from sensor data of a physical-chemical process in a chemical plant comprising:
(a) receiving a training dataset based on sets of historical data comprising sensor data and physical-chemical parameters related to the physical-chemical process,
(b) training a plant model by adjusting the parameterization according to the training dataset, wherein the plant model comprises:
   a mechanistic model containing at least two equations each representing a part of the physical-chemical process, and
   at least one data-driven model associated to the mechanistic model, wherein the total number of scalars as output parameters from the at least one data-driven model is lower than the number of equations of the mechanistic models, and
(c) outputting the trained plant model.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates the method and system of the present invention.

FIG. 2 illustrates an example of a plant model.

FIG. 3 illustrates another example of a plant model.

FIG. 4 illustrates another example of a plant model.

FIG. 5 illustrates an example for determining the sensitivity for different plant model modifications.

FIG. 6 illustrates an example of a production process in which the present invention is used.

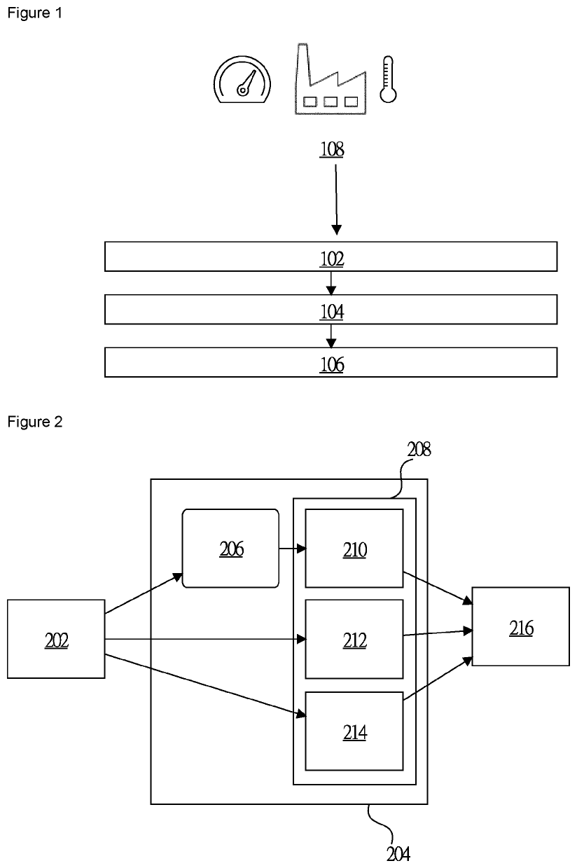

The present invention relates to a method for monitoring and/or controlling a physical-chemical process in a chemical plant. FIG. 1 illustrates a potential implementation of the present invention. Sensor data from a plant 108 is received by an input 102. The sensor data is provided to a processor 104 which is programmed to execute a plant model. This plant model uses the sensor data as input und has a physical-chemical parameter as output. The physical-chemical parameter is output by an output 106.

“Monitoring” refers to the observation and recording of any state of operation of the chemical plant. The state of operation includes internal parameters, such as those parameters which are solely relevant within the plant such as reactor temperature, pressure, electricity consumption, input or output material flows, rotational speeds of stirrers, states of valves, concentrations of vapors in the air within the plant, number of people inside the plant. The state of operation also includes external parameters, such as parameters which relate to any exchange with the environment of the plant, such as emission of chemical vapors, heat, sound, vibrations, light. Recording can mean storing the raw data onto a permanent data storage device or preparing documents in a format which are required by the company or by authorities.

“Controlling” refers to taking any actions to change the state of operation of the chemical plant. The actions can be direct, for example by changing the state of a valve, changing the temperature by additional heating or increasing the cooling. The actions can also be indirect, for example by prompting an operator to take actions, for example exchanging a filter or adjusting throughput.

“Physical-chemical process” refers to any process which involves the handling or modification of at least one substance, such as a chemical compound or a composition. Physical-chemical processes include chemical reactions; purifications such as distillation, crystallization, filtration, centrifugation, decantation, floatation; formulations such mixing, spray drying, co-extrusion, coating; or shape-changing process such as grinding, molding, agglomeration, extrusion.

“Chemical reaction” refers to a physical-chemical process involving the chemical transformation of one set of chemical species to another. A chemical reaction can in principle contain one elementary reaction. However, in practice, most chemical reactions contain more than one elementary reaction. The chemical reaction can contain elementary reactions in series or in parallel or both. An example for a chemical reaction containing a series of elementary reactions is a condensation reaction in which firstly a nucleophilic species adds to an electrophilic species as a first elementary reaction followed by the elimination of a small species, like water, as a second elementary reaction. An example for a chemical reaction containing several elementary reactions in parallel is a combustion reaction in which a chemical species reacts with oxygen forming various different partially oxidized species.

Chemical reactions can be operated in a homogeneous or heterogeneous way. Homogeneous chemical reactions involve one phase, for example in a gas phase or in a liquid phase, such as a solution. Heterogeneous chemical reactions involve at least two phases. The at least two phases can be of different state of matter, for example one phase is solid and one phase is liquid, or one phase is solid and the other phase is gaseous, or one phase is liquid and the other phase is gaseous. The at least two phases can be of the same state of matter it they are immiscible, for example two immiscible liquid phases or two immiscible solid phases.

Chemical reactions can be operated in a continuous or discontinuous way, sometimes also referred to as batch chemical reactions. In a continuous chemical reaction, the reagents are continuously fed into a reactor where the reaction takes place and at the same time the products are continuously output from the reactor. In a discontinuous chemical reaction, a reactor is charged with the reagents, then the reaction takes place and after that the products are collected from the reactor. The reactor may be cleaned and is then again charged with new reagents.

“Elementary reaction” refers to a chemical reaction in which one or more chemical species react directly to form products in a single reaction step without intermediates which can be observed or even be isolated. An elementary reaction can usually be described as a reaction having a single transition state.

“Chemical plant” refers to any technical infrastructure that is used for an industrial purpose of manufacturing, producing or processing of one or more chemical products, i.e., run chemical reactions to produce chemical compounds, produce formulations by blending chemical compounds, increase the purity of a chemical compound, obtain chemical compounds by recycling waste, bring chemical compounds in a different form, or package chemical compounds or formulations containing chemical compounds.

The infrastructure of a chemical plant may comprise equipment or process units such as any one or more of a heat exchanger, a column such as a fractionating column, a furnace, a reaction chamber, a cracking unit, a storage tank, an extruder, a pelletizer, a precipitator, a blender, a mixer, a cutter, a curing tube, a vaporizer, a filter, a sieve, a pipeline, a stack, a filter, a valve, an actuator, a mill, a transformer, a conveying system, a circuit breaker, a machinery e.g., a heavy duty rotating equipment such as a turbine, a generator, a pulverizer, a compressor, an industrial fan, a pump, a transport element such as a conveyor system, a motor, etc.

Further, a chemical plant typically comprises a plurality of sensors and at least one control system for controlling at least one parameter related to the process, or process parameter, in the plant. Such control functions are usually performed by the control system or controller in response to at least one measurement signal from at least one of the sensors. The controller or control system of the plant may be implemented as a distributed control system (“DCS”) and/or a programmable logic controller (“PLC”).

Thus, at least some of the equipment or process units of the chemical plant may be monitored and/or controlled for producing one or more of the industrial products. The monitoring and/or controlling may even be done for optimizing the production of the one or more products. The equipment or process units may be monitored and/or controlled via a controller, such as DCS, in response to one or more signals from one or more sensors. In addition, the plant may even comprise at least one PLC for controlling some of the processes. The chemical plant may typically comprise a plurality of sensors which may be distributed in the chemical plant for monitoring and/or controlling purposes. Such sensors may generate a large amount of data. The sensors may or may not be considered a part of the equipment. As such, production, such as chemical and/or service production, can be a data heavy environment. Accordingly, each chemical plant may produce a large amount of process related data.

Those skilled in the art will appreciate that the chemical plant usually comprises instrumentation that can include different types of sensors. Sensors may be used for measuring one or more process parameters and/or for measuring equipment operating conditions or parameters related to the equipment or the process units. For example, sensors may be used for measuring a process parameter such as a flowrate within a pipeline, a level inside a tank, a temperature of a furnace, a chemical composition of a gas, etc., and some sensors can be used for measuring vibration of a pulverizer, a speed of a fan, an opening of a valve, a corrosion of a pipeline, a voltage across a transformer, etc. The difference between these sensors cannot only be based on the parameter that they sense, but it may even be the sensing principle that the respective sensor uses. Some examples of sensors based on the parameter that they sense may comprise: temperature sensors, pressure sensors, radiation sensors such as light sensors, flow sensors, vibration sensors, displacement sensors and chemical sensors, such as those for detecting a specific matter such as a gas. Examples of sensors that differ in terms of the sensing principle that they employ may for example be: piezoelectric sensors, piezoresistive sensors, thermocouples, impedance sensors such as capacitive sensors and resistive sensors, and so forth.

A plurality of chemical plants may form a larger production unit. The term “plurality of chemical plants” as used herein is a broad term and is to be given its ordinary and customary meaning to a person of ordinary skill in the art and is not to be limited to a special or customized meaning. The term specifically may refer, without limitation, to a compound of at least two chemical plants having at least one common industrial purpose. Specifically, the plurality of chemical plants may comprise at least two, at least five, at least ten or even more chemical plants being physically and/or chemically coupled. The plurality of chemical plants may be coupled such that the chemical plants forming the plurality of chemical plants may share one or more of their value chains, educts and/or products. The plurality of chemical plants may also be referred to as a compound, a compound site, a Verbund or a Verbund site. Further, the value chain production of the plurality of chemical plants via various intermediate products to an end product may be decentralized in various locations, such as in various chemical plants, or integrated in the Verbund site or a chemical park. Such Verbund sites or chemical parks may be or may comprise one or more chemical plants, where products manufactured in the at least one chemical plant can serve as a feedstock for another chemical plant.

“Sensor data” refers to any data which represents the operational state of the production plant or parts of it as measured by sensors of the chemical plant. The sensor data may be received directly from the sensors. Typically, the sensor data are collected by a digital signal controller or programmable logic controller of the chemical plant and further transmitted from there. The sensor data may be adjusted, for example by a calibration system before being transmitted. The sensor data from the chemical plant may also be stored on a storage medium, for example a database on a hard drive or in a cloud system. Hence, the sensor data may be obtained from such storage medium for the purpose of the present invention.

The sensor data can comprise any measurable physical-chemical value, such as temperature, pressure, pH, concentration or partial pressure of a compound such as oxygen or water content, flow rate of reagents, of the reaction mixture in the reactor or of the products after the reactor, stirrer speed, viscosity, turbidity. Usually, the sensor data also comprises the location of the sensor, in particular if more than one sensor measures at different locations of the equipment. A typical example is a pressure sensor at the inlet of a reactor and one at the outlet of a reactor. The sensor data can also comprise time information, i.e. the time at which the sensor has collected the physical-chemical information, sometimes referred to as time stamp.

The sensor data is related to the physical-chemical process which is monitored and/or controlled. The term “related” has to be understood in a broad way, namely any information of a sensor which has an influence on the physical-chemical process or correlates to the state of the physical-chemical process.

The sensor data may be received directly from sensors in the chemical plant or it may be received from a data storage medium. The sensor data on the data storage medium may be recorded sensor data or manipulated sensor data. A reason for manipulating sensor data may be to simulate deviations and analyze the impact on the physical-chemical parameters with the goal to control the physical-chemical process in case such situation happens in reality. An example could be a change in heat supply and one may want to analyze if such heat supply can be compensated by increased pressure or a change in flow rates.

For controlling a chemical plant, however, the sensor data is preferably received directly from the sensors in the chemical plant, preferably in real-time. Real-time relates to a low latency, i.e. with a latency of less than 10 seconds or even less than one second. Typically, the lower the latency, the higher the precision of controlling the chemical plant.

The method according to the present invention comprises (b) determining at least one physical-chemical parameter by providing the sensor data to a plant model.

“Physical-chemical parameter” refers to those pieces of information characterizing the physical-chemical process and which can in theory be measured. However, in practice, this is usually not possible directly by a sensor, for example because no suitable sensor exists, the sensors cannot be placed at a position where the information can be detected or such measurements are economically unfavorable. Physical-chemical parameters can refer to a chemical species, for example chemical composition, concentration, pressure, purity, viscosity, turbidity. Physical-chemical parameters can also refer to the catalysts, if use, for example chemical composition, concentration, pressure, purity, activity, age, surface area. Physical-chemical parameters can also refer to the equipment, for example total pressure, temperature, flow rate at certain parts, for example pipes, pressure drop along certain parts, amount and/or rate of deposition of insoluble material on walls, also called fouling, heat flow, for example in a heat exchanger.

Usually, those physical-chemical parameters are determined which have the highest relevance for monitoring and/or controlling the chemical reaction. Physical-chemical parameters of particular relevance for monitoring and/or controlling are reaction yield, catalyst activity and equipment fouling. For some cases it is sufficient to determine one physical-chemical parameter. In other cases, it is beneficial to determine more than one reaction parameters, for example at least two, three, five or ten. In that way, a more detailed view of the chemical reaction can be obtained, so well-suited measures can be taken to control the chemical reaction. Determination is performed by providing the sensor data to a plant model.

“Plant model” refers to a model which mathematically describes a physical-chemical process or multiple physical-chemical processes in a chemical plant. The plant model receives sensor data as input and outputs the physical-chemical parameters. The plant model comprises a mechanistic model and a data-driven model. Hence, the plant model may be referred to as a hybrid model.

“Mechanistic model” refers to a model which is based on the fundamental laws of natural sciences, for example any one or more of physical, chemical, biochemical principles, heat and mass balancing. Such models thus represent these principles using equations. A mechanistic model can comprise linear or nonlinear ordinary differential equations, linear or nonlinear partial differential equations, linear or nonlinear algebraic equations, or linear or non-linear differential algebraic equations. Such equations relate to a physical-chemical process.

A typical example for a mechanistic model is a chemical kinetic model modeling a physical-chemical process. Essentially, such a model is composed of ordinary differential equations or differential algebraic equations describing the dynamics of chemical species that are being consumed or produced by a set of chemical reactions. The system of ordinary differential equations or differential algebraic equations are usually composed of rate laws that are algebraic equations describing the speed at which chemical species are consumed or produced in reactions. Such an algebraic equation typically depends on the concentrations of the chemical species, temperature in the given reaction and constants, which are usually temperature dependent. Furthermore, certain invariances, such as conservation of mass, can also be represented in such a mechanistic model as algebraic equations.

It may be known which mechanistic models fit best to a certain physical-chemical process. In this case, the selection of adequate mechanistic models is straight forward. If, however, it is not known which mechanistic models fit well to the physical-chemical process, one may select a set of mechanistic models for a similar physical-chemical process. Sometimes, there may not be a similar physical-chemical process available, maybe because the underlying mechanism is not yet known or the appropriate information is not available for a different reason. In this case, it may be sufficient to pick an arbitrary mechanistic model from a model library which contains various mechanistic models for known physical-chemical process. Obviously, such an arbitrary mechanistic model will not fit very well to a given physical-chemical process. However, an associated data-driven model may compensate at least part of the deviation, so the result may be sufficient for less demanding purposes. Alternatively, one arbitrarily picks different mechanistic models, tries one after the other and selects the mechanistic model which fits best to the physical-chemical process. Such selection can be automated. Hence, the mechanistic models may be selected from a model library, for example by a computer program, by arbitrarily selecting several mechanistic models, applying one after the other to the physical-chemical process, determining how well the mechanistic model fits to the physical-chemical process and selecting the best fitting mechanistic model.

“Data-driven model” refers to a mathematical model that is parametrized according to a training data set to reflect physical-chemical processes such as reaction kinetics of the production plant. The training data set may comprise sensor data and physical-chemical parameters obtained from experiments or earlier production runs. In contrast to a mechanistic model that is purely derived using physical-chemical laws, a data-driven model can allow describing relations that are difficult or even impossible to be modelled by physical-chemical laws. Data-driven models are set up without reflecting any underlying physical laws of nature. These are taken into account solely by using the correlations in the data.

The data-driven model is preferably a data-driven machine learning model. The data-driven model can be a linear or polynomial regression, a decision tree, a random forest model, a Bayesian network, support-vector machine or, preferably an artificial neural network.

According to the present invention the plant model comprises a mechanistic model comprising at least two equations each representing a part of the physical-chemical process. In the case of a chemical reaction, each equation may represent an elementary reaction of the chemical reaction or each equation represent several elementary reactions, for example by approximating them with one hypothetical elementary reaction. In the case of a distillation, each equation may represent the vaporization and condensation of one compound. The plant model further comprises at least one data-driven model associated to at least one mechanistic model. The term “associated” means that there is a data exchange between the mechanistic model and the data-driven model. For example, the output of a data-driven model can be used as input for an equation of the mechanistic model or the output of an equation of the mechanistic model can be used as input for a data-driven model. It is possible that the output of a data-driven model is used in more than one equation of the mechanistic model. In this case, it is possible that the data-driven model outputs one scalar as output parameter which is used as input in more than one equation of the mechanistic model, for example in two or three. It is even possible that the one output parameter of the data-driven model is used in all equations of the mechanistic model. If the output of a mechanistic model is used as input for a data-driven model it is possible that one output parameter of a mechanistic model is used in one data-driven model or in more than one data-driven models, for example in two, three. It is even possible that the one output parameter of the mechanistic model is used in all data-driven models. It is also possible that a mechanistic model has more than one scalar as output parameters, wherein each output parameter is used in a different data-driven model. It is also possible that a mechanistic model has more than one output parameters, wherein some are used in more than one data-driven models and others are only used in one data-driven model. It is also possible that the output of a mechanistic model is used as input for a data-driven model and the output of this data-driven model is used again as input for the mechanistic model, hence forming a feedback loop. This can be useful for physical-chemical processes in which some of the product is recycled by using it as reagent again.

According to the present invention the total number of scalars as output parameters from the at least one data-driven model is lower than the number of equations of the mechanistic model. The term “total number” means the sum of all scalars as output parameters of all data-driven models. In the present context, an output parameter can be scalar, so the number of scalars as output parameters is equal to the number of output parameters. An output parameter can be a vector or matrix. In this case the total number of scalars as output parameters refers to the number of entries or elements of that vector or matrix.

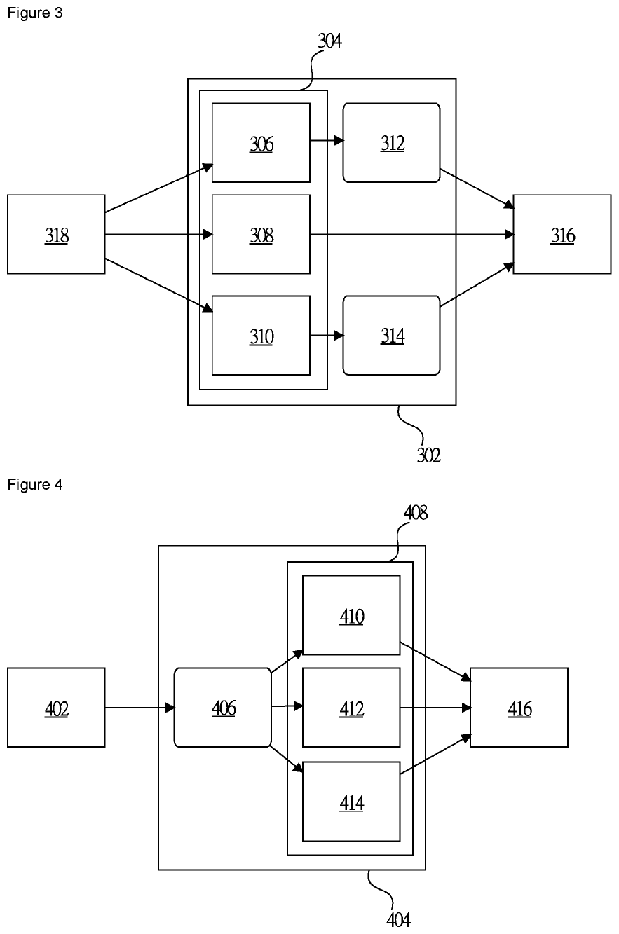

The plant model contains at least one data-driven model. It can contain one data-driven model, or it can contain more than one data-driven models, for example two or three. More than one data-driven model can be all the same or different to each other, for example a plant model may contain a polynomial regression and an artificial neural network. If one data-driven model is used, the total number of scalars as output parameters equals the number of output physical-chemical parameters of that data-driven model. If more than one data-driven models is used, the number of scalars as output parameters for each data-driven model is added to arrive at the total number of scalars as output parameter. FIG. 2, FIG. 3 and FIG. 4 show some examples of how plant models may look like if the physical-chemical process is represented by a mechanistic model containing three equations. For the sake of illustration, the rounded boxes represent a data-driven model having only one output parameter. For a data-driven model with more than one output parameter, a respective number of rounded boxes would be displayed.

FIG. 2 illustrates a plant model 204 containing a data-driven model 206 which receives sensor data 202 as input. The output of data-driven model 206 is used as input for mechanistic model 208 which may use sensor data 202 as additional input. For example, data-driven models 206 may output a correction constant for the equation 210. The equations 212 and 214 only use sensor data 202 as input. The plant model 204 outputs physical-chemical parameter 216. FIG. 3 illustrates another plant model 302 containing two data-driven models 312 and 314. These receive the output of equations 306 and 310 as input and each output a physical-chemical parameter 316. For example, the equations 306 and 310 may output physical-chemical parameters which are corrected by the data-driven models 312 and 314. The equation 308 is not associated with a data-driven model.

FIG. 4 illustrates another plant model 404. It contains one data-driven model 406 which receives sensor data as input. Its output is used as input in all equations 410, 412 and 414. The equations 410, 412 and 414 output the physical-chemical parameter 416.

The data-driven model usually uses sensor data as input, sometimes in addition to the output of the equations of the mechanistic model. In order to reduce the need for a high amount of historic data and at the same time have a high accuracy of the plant model, it is advantageous to reduce the input of the data-driven model to a minimum. Consequently, only a part of the sensor data is used as input for the data-driven model. Appropriate selection of sensor data used as input for the data-driven model may include one or more of the following options:

i) Subset selection by identifying a data-driven model with a subset of input parameters with an accuracy which is close to the accuracy of data-driven model with full input parameters. Several techniques to efficiently identify such a subset is known in the literature.

ii) Regularization or shrinkage approach usually applicable to neural network and linear regression based methods where the contribution of the some of the input parameters are shrunken towards zero or are set to zero. This is usually accomplished by penalizing the loss function of the data-driven model.

iii) Dimensionality reduction is a projection method e.g. Principal Component Analysis, where the input parameters are projected to a reduced dimensional space resulting in “derived input parameters” which are then used in the data-driven model. An introduction to these approaches could be found in: James, Gareth, et al. An introduction to statistical learning. Vol. 112. New York: springer, 2013.

Essentially, all these approaches reduce the data-driven model complexity by performing a selection of input parameters associated with the data-driven model by dropping less relevant variables or finding a lower dimensional “derived input parameters” space.

Plant models used in the present invention are typically more accurate than mechanistic models alone, but require less historic data to train the data-driven models in comparison to conventional hybrid models. This effect is particularly expressed if those output parameters of the data-driven model with the highest sensitivity are selected.

“Sensitivity” refers to the impact such output parameter has on the physical-chemical parameters, i.e. the relative difference of the physical-chemical parameters when the output parameters of the data-driven model are varied, i.e. increased or decreased. In some cases, it is sufficient to select only the output parameter with the highest sensitivity. In other cases, it may be necessary to use the two or three output physical-chemical parameters with the highest sensitivity. Usually, the number of selected output parameters is a tradeoff between available historic data and required accuracy of the reaction parameters.

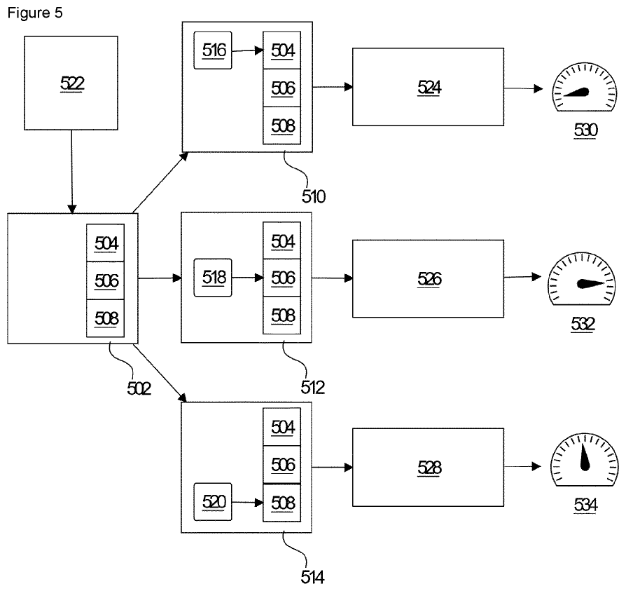

In some cases an expert in reaction modelling may be able to make a direct selection of the output parameters of the data-driven model. Often, however, the situation is complex, so the sensitivity has to be systematically determined before being able to select the appropriate output parameters. FIG. 5 illustrates a way how to determine the sensitivity of an output parameter. Starting from physical-chemical process scheme 522 which contains the details of the physical-chemical process in the chemical plant a plant model 502 is generated. This plant model 502 contains a mechanistic model containing an equation for each part of the physical-chemical process (504, 506, 508). Based on plant model 502 derived plant models (510, 518, 526) are generated by associating a data-driven model with the mechanistic model, wherein in each plant model (510, 512, 514) a data-driven model is associated with the mechanistic models in a different way. In the present example, the output of a data-driven model is used as input for one of the equations of the mechanistic model. Obviously, more options are conceivable, for example using the output of the data-driven model for more than one equation of the mechanistic model or using a data-driven model which uses the output of one or more than one equation of the mechanistic models as input. For each plant model (510, 512, 514), the data-driven model is trained with historic data. Then, validation data is used to determine the output (524, 526, 528) for each plant model (510, 512, 514). For each plant model (510, 512, 514) the output of the data-driven model is varied, and the change of the output is determined. The relative difference indicates the sensitivity. The plant model for which the highest sensitivity was found may be used for the method of the present invention. In this example, plant model 502 exhibits low sensitivity 530, plant model 512 exhibits high sensitivity 532, and plant model 514 exhibits medium sensitivity 534.

The plant model may further comprise a consolidation model which consolidates the output of the mechanistic models and/or data-driven models into the physical-chemical parameter. This is in particular useful for chemical reactions comprising a series of reaction steps, i.e. the product of one reaction steps is the reagent of the next reaction step. A consolidation model is usually based on boundary conditions which are apparent from laws of nature. A typical boundary condition is the mass balance: a chemical reaction neither creates nor destroys mass, but only converts chemical species into one another. Other boundary conditions can be minimum or maximum values for certain parameters, for example concentrations cannot be negative, or pressures cannot be significantly different in openly connected volumes.

The plant model is trained with a training dataset based on sets of historical data comprising sensor data and physical-chemical parameters related to the chemical reaction. “Historical data” refers to data sets including at least sensor data and physical-chemical parameters, wherein each data set is associated with a single physical-chemical process run. Hence each data set includes data associated with the physical-chemical process run in a predefined time period. For a batch process such predefined time period may be the beginning to the end of one batch run. For a continuous process, a characteristic period may be chosen, for example the time from charging a reactor with a catalyst until it needs to be replaced by new catalyst. Historic data can be obtained from an already existing plant to be monitored or controlled. However, it can also originate from a laboratory, a pilot plant or a similar plant. Sometimes historic data from more than one of these are available.

Training the plant model is typically done by adjusting the parameterization according to the training dataset. Adjusting the parameterization in this context means varying the parameters in the data-driven model comprised in the plant model such that the output of the plant model most closely resembles the reaction parameters of the training set. Depending on the type of data-driven model, various methods of doing so are known and well described in the literature.

The method according to the present invention further comprises (c) outputting the at least one physical-chemical parameter determined by the plant model. Outputting can mean writing the physical-chemical parameter on a non-transitory data storage medium, for example into a monitoring file or a control file, display it on a user interface, for example a screen, or both. The method according to the present invention may be referred to as a soft sensor or virtual sensor which measures a physical-chemical parameter indirectly by computationally deriving them from observable quantities represented by sensor data.

It is also possible to output the physical-chemical parameter through an interface to a control system. Such control system may receive the physical-chemical parameter and based on such physical-chemical parameter change settings of equipment in the chemical plant in which the physical-chemical process takes place. As an example, the plant model has determined a catalyst activity decrease of a certain value compared to a maximum catalyst activity. The control system may receive the catalyst activity and cause an input valve to decrease the flow rate of reagents through a reactor. In this way, the reagents stay longer in proximity to the catalyst, so the decreased catalyst activity is compensated. Hence, the reagents can fully react to yield the desired products in high yield and good quality.

The present invention further relates to a non-transitory computer-readable data medium storing a computer program including instructions for executing steps of the method according to the present invention. “Computer-readable data medium” refers to any suitable data storage device or computer readable memory on which is stored one or more sets of instructions (for example software) embodying any one or more of the methodologies or functions described herein. The instructions may also reside, completely or at least partially, within the main memory and/or within the processor during execution thereof by the computer, main memory, and processing device, which may constitute computer-readable storage media. The instructions may further be transmitted or received over a network via a network interface device. Computer-readable data medium include hard drives, for example on a server, USB storage device, CD, DVD or Blue-ray discs. The computer program may contain all functionalities and data required for execution of the method according to the present invention or it may provide interfaces to have parts of the method processed on remote systems, for example on a cloud system.

The present invention further relates to a production monitoring and/or control system for monitoring and/or controlling a physical-chemical process in a chemical plant. Such system is configured to execute the method according to the present invention. Hence, all definition, examples and preferred embodiments described for the method also apply to the system.

The system according to the present invention comprises an input configured to receive sensor data related to the physical-chemical process. Such input may comprise an interface for receiving the sensor data. The input may receive the sensor data locally or remotely, for example via an interface to a telecommunication system, such as the internet. The input may receive the sensor data directly from the sensors, or via a programmable logic controller, a distributed control system, or a storage medium including a cloud service. It is even possible that the system is part of a distributed control system.

The system further comprises a processor configured to determine at least one physical-chemical parameter. The processor may be a local processor comprising a central processing unit (CPU) and/or a graphics processing units (GPU) and/or an application specific integrated circuit (ASIC) and/or a tensor processing unit (TPU) and/or a field-programmable gate array (FPGA). The processor may also be an interface to a remote computer system such as a cloud service.

### EXAMPLE

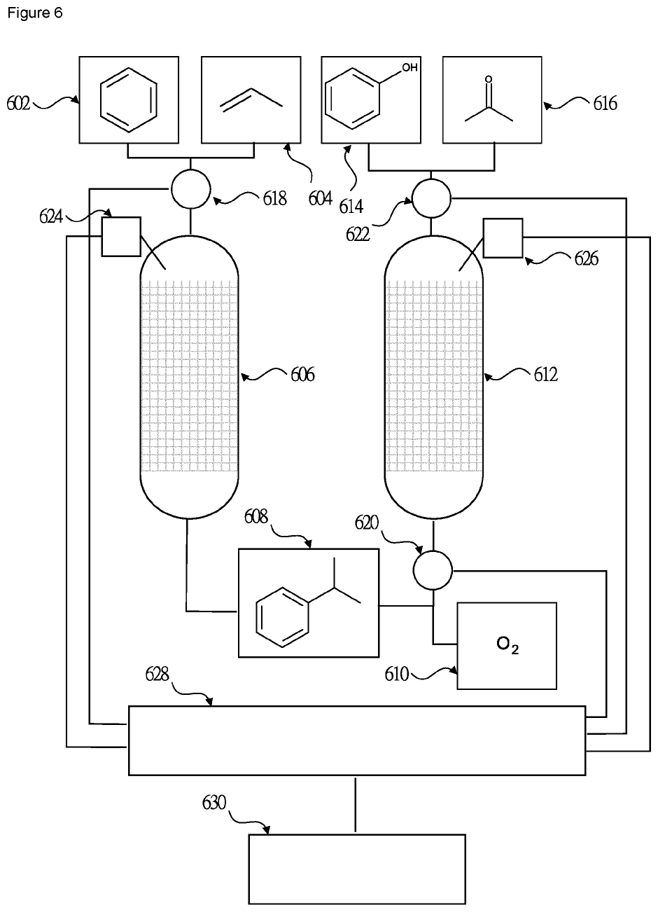

To further illustrate the invention, FIG. 6 illustrates an example for a chemical reaction in a chemical plant producing phenol and acetone in two steps from benzene and propene: from benzene supply 602 and propene supply 604 benzene and propene are mixed and injected into tubular reactor 606 controlled by valve 618. Tubular reactor 606 has a solid bed containing a Friedel Crafts acylation catalyst which converts benzene into cumene 608. Cumene 608 is fed together with oxygen 610 into tubular reactor 612 controlled by a valve 620. Tubular reactor 612 also has a solid bed containing an oxidation catalyst which converts cumene into phenol and acetone. The product flow is controlled by valve 622. Phenol and acetone are collected and purified. The reactors are equipped with temperature sensors 624 and pressure sensors 626 which measure temperature and pressure and transfer these values to a distributed control system 628. The valves 618, 620 and 622 are equipped with a sensor to measure the gas flow, so the partial pressure of each reagent can be determined. The corresponding values are also transferred to the distributed control system 628.

Hence, the sensor data collected by the distributed control system 628 comprises total mass flow per area (G_{z}) the partial pressure of propene (pₚᵣ), the partial pressure of benzene (p_{Bz}), the partial pressure of oxygen (pₒ₂), the partial pressure of cumene (p_{Cm}), the temperature in tubular reactor 606 (T₁), the temperature in tubular reactor 612 (T₂). The distributed control system 628 transfers the sensor data to the processor 630 which executes a plant model. The plant model comprises a neural network using these sensor data and reactor configurations as input parameters and a parameter fun as output. The neural network has one hidden layer. The parameter fun is used as input for the mechanistic model containing two equations as described below.

The mechanistic model contains one equation for the rate constant for each elementary reaction. For the reaction of benzene and propene to cumene, the following equation is used, wherein k₁ and E_{A1} are constants found in the literature for this reaction:

$${r}_{Cm} = {f}_{NN} \cdot {k}_{1} {e}^{- \frac{{E}_{{A}_{1}}}{{E}_{{A}_{2}}}} \cdot \frac{{p}_{pr}}{{p}_{Bz}}$$

For the reaction in tubular reactor 612 forming phenol and acetone from cumene, the following equation is used, wherein k₂ and E_{A2} are constants found in the literature for this reaction:

$${r}_{Pk} = {f}_{NN} \cdot {k}_{2} {e}^{- \frac{{E}_{{A}_{1}}}{{E}_{{A}_{2}}}} \cdot \frac{{p}_{{C}_{m}}}{{p}_{{O}_{2}}}$$

The yield of phenol and acetone as physical-chemical parameters are determined by using the consolidation model obtained from the mass balance separately for each reaction step, wherein yᵢ is the mass fraction of component i, ρ_{cat} is the filling density of the catalyst, M_{w,i} is the molecular mass of component i and vᵢ is the stoichiometric coefficient of component i:

$${G}_{z} \frac{\partial {y}_{i}}{\partial z} = {M}_{w , i} \cdot {ρ}_{cat} {\sum }_{j} {v}_{i , j} {r}_{j}$$

The yield of phenol and acetone is transferred back form the processor 630 to the distributed control system 628. If the yield goes down indicating a decreased catalyst activity, the distributed control system 628 may decrease the gas flow of benzene and propylene by operating valves 618. Alternatively, the distributed control system 628 may decrease the gas flow of cumene and oxygen by operating valve 620. In this way, the time the benzene and propylene or the cumene and oxygen are in contact with the catalyst is increased which may lead to a higher conversion rate bringing back up the product yield.

1. A computer-implemented method for monitoring and/or controlling a physical-chemical process in a chemical plant comprising:
(a) receiving sensor data related to the physical-chemical process,
(b) determining at least one physical-chemical parameter by providing the sensor data to a plant model, wherein the plant model comprises:
i. a mechanistic model containing at least two equations each representing a part of the physical-chemical process, and
ii. a data-driven model associated to the mechanistic model, wherein the data-driven model has been trained with a training dataset based on sets of historical data comprising sensor data and physical-chemical parameters related to the chemical reaction and wherein the total number of scalars as output parameters from the data-driven model is lower than the number of equations of the mechanistic model, and
(c) outputting the at least one physical-chemical parameter determined by the plant model.

2. The computer-implemented method of claim 1, wherein the at least one physical-chemical parameter comprises at least one of reaction yield, catalyst activity or equipment fouling.

3. The computer-implemented method of claim 1, wherein the sensor data comprises temperature, pressure and flow rate of reagents.

4. The computer-implemented method of claim 1, wherein the output of the data-driven model is used as input for at least one equation of the mechanistic model.

5. The computer-implemented method of claim 1, wherein the data-driven model is an artificial neural network.

6. The computer-implemented method of claim 1, wherein the at least one physical-chemical parameter is output to a control system capable of changing settings of equipment in the chemical plant in which the physical-chemical process takes place based on the physical-chemical parameter.

7. The computer-implemented method of claim 1, wherein the output parameters from the at least one data-driven model is selected based on the sensitivity of the output parameters, wherein sensitivity is the relative difference of the physical-chemical parameters when the output parameters of the data-driven model are varied.

8. The computer-implemented method of claim 1, wherein the data-driven model uses parts of the sensor data determined by one or more of subset selection, regularization and dimensionality reduction.

9. A non-transitory computer-readable data medium storing a computer program comprising instructions for executing steps of the method according to claim 1.

10. A method for monitoring and/or controlling a chemical plant using the physical-chemical parameter obtained according to claim 1.

11. A production monitoring and/or control system for monitoring and/or controlling a physical-chemical process in a chemical plant comprising:
(a) an input configured to receive sensor data related to the physical-chemical process,
(b) a processor configured to determine at least one physical-chemical parameter by providing the sensor data to a plant model, wherein the plant model comprises:
i. a mechanistic model containing at least two equations each representing a part of the physical-chemical process, and
ii. at least one data-driven model associated to the mechanistic model, wherein the data-driven model has been trained with a training dataset based on sets of historical data comprising sensor data and physical-chemical parameters related to the chemical reaction and wherein the total number of scalars as output parameters from the at least one data-driven model is lower than the number of equations of the mechanistic models, and
(c) an output configured to output the at least one physical-chemical parameter determined by the plant model.

12. The production monitoring and/or control system of claim 11, wherein the system is part of or in connection with a distributed control system of the chemical plant.

13. The production monitoring and/or control system of claim 11, wherein the sensor data is received from sensors in the chemical plant.

14. A method for training a plant model suitable for determining at least one physical-chemical parameter from sensor data of a physical-chemical process in a chemical plant comprising:
(a) receiving a training dataset based on sets of historical data comprising sensor data and physical-chemical parameters related to the physical-chemical process,
(b) training a plant model by adjusting the parameterization according to the training dataset, wherein the plant model comprises:
i. a mechanistic model containing at least two equations each representing a part of the physical-chemical process, and
ii. at least one data-driven model associated to the mechanistic model, wherein the total number of scalars as output parameters from the at least one data-driven model is lower than the number of equations of the mechanistic models, and
(c) outputting the trained plant model.

15. The method of claim 10, wherein the physical-chemical parameter is used to change settings of equipment in the chemical plant.
